(19) United States
(12) Patent Application Publication
(10) Pub. No.: US 2008/0073819 A1
(43) Pub. Date: Mar. 27, 2008

(54) Method of manufacturing sputtering targets

(75) Inventors: Hsin-Chun Lu, Taipei City (TW); Chih-Ming Hsieh, Jhongli City (TW); Yi-Chieh Chen, Kaohsiung City (TW); Cherng-Yuan Shiao, Jhongli City (TW); Kuo-Shu Hsu, Banciao City (TW)

Correspondence Address: TROXELL LAW OFFICE PLLC, SUITE 1404, 5205 LEESBURG PIKE, FALLS CHURCH, VA, 22041, US

(73) Assignee: CHENG LOONG CORPORATION

(21) Appl. No.: 11/526,076

(22) Filed: Sep. 25, 2006

(51) Int. Cl. C04B 35/64

(52) U.S. Cl. 264/674

(57) ABSTRACT

A method of manufacturing sputtering targets comprises the following steps of: 1. wet milling: mixing and grinding indium-tin oxide (ITO) powders, a sintering aid agent, a binder agent, and additive agent by wet milling method; 2. granulation: drying the mixed and grinded mixtures to form granulated ITO powers; 3. shaping: granulated ITO powders into rough-shaped green bodies by using dry pressing; 4. strengthening: strengthening the rough-shaped green bodies by using the cold isostatic pressing; 5. dewaxing: putting rough-shaped green bodies into a high-temperature furnace to remove the additive agent so as to obtain dewaxed green bodies; and 6. sintering: putting the dewaxed green bodies into an controlled atmosphere furnace and sintering the dewaxed green bodies at a gas pressure ranged from 1.1 atm to 1.9 atm. By using the above-mentioned steps, the high-density ITO sputtering targets are obtained.

### FIELD OF THE INVENTION

The present invention relates to a method of manufacturing a high-density sputtering target to decrease the loss of material, and more particularly to a manufacturing method that is suitable for producing sputtering targets used in the manufacturing of LCD panels or the likes.

### BACKGROUND OF THE INVENTION

The indium tin oxide (ITO) films have high electrical conductance, high visible light transmittance, and high IR (infrared ray) reflectance. As a result, the ITO films have been widely applied to several electro-optic and opto-electric products including transparent electrodes of solar cells, switching devices of flat panel displays, and electromagnetic interference (EMI) films. In addition, the ITO films are particularly suitable for use as transparent conductive electrodes of LCD panels.

The ITO films can be manufactured by several methods including vacuum evaporation, magnetron sputtering, chemical vapor deposition, and dip coating, wherein the sputtering method is particularly suitable for large-area substrates and its process temperature is lower. As a result, it can save energy and prevent the generation of poisonous materials. Consequently, the ITO films are typically produced by sputtering.

Generally, sputtering oxide targets are manufactured by mixing different oxides. The powders of these different oxides are mixed by mechanical methods; for example, ball milling. The mixed powders are dried and then processed by dry pressing to form green bodies. Finally, the green bodies are sintered to form sputtering targets. However, in the conventional sintering process, the gas pressure is usually lower than normal pressure (1 atm.), so the oxygen (O₂) required sintering time is very long. In other words, the long sintering process consumes much more energy. Moreover, the long sintering process causes the oxides to be decomposed and causes the loss of materials.

In view of the foregoing problems, the present invention discloses a method of manufacturing sputtering targets to shorten the sintering time and decrease the loss of materials.

### SUMMARY OF THE INVENTION

The main object of the present invention is to provide a method of manufacturing sputtering targets to shorten the sintering time and to decrease the loss of materials.

Another object of the present invention is to provide a method of manufacturing sputtering targets for increasing the density of the sputtering targets.

In order to achieve the above-mentioned objects, a method of manufacturing sputtering targets comprises the following steps of: 1. wet milling: mixing and grinding indium-tin oxide (ITO) powders, a sintering aid agent, a binder agent, and additive agent by wet milling method; 2. granulation: drying the mixed and grinded mixtures to form granulated ITO powers; 3. shaping: granulated ITO powders into green bodies by using dry pressing; 4. Strengthening: strengthening the green bodies by cold isostatic machine; 5. dewaxing: putting green bodies into a high-temperature furnace to remove the additive agent so as to obtain dewaxed green bodies; and 6. sintering: putting the dewaxed green bodies into an controlled atmosphere furnace and sintering the dewaxed green bodies at a gas pressure ranged from 1.1 atm to 1.9 atm. By using the above-mentioned steps, high-density ITO sputtering targets are obtained.

The aforementioned objects and advantages of the present invention will be readily clarified in the description of the preferred embodiments and the enclosed drawings of the present invention.

### BRIEF DESCRIPTION OF THE DRAWINGS

FIG. 1 is a diagram showing the manufacture process of the present invention.

### DETAILED DESCRIPTION OF THE PREFERRED EMBODIMENT

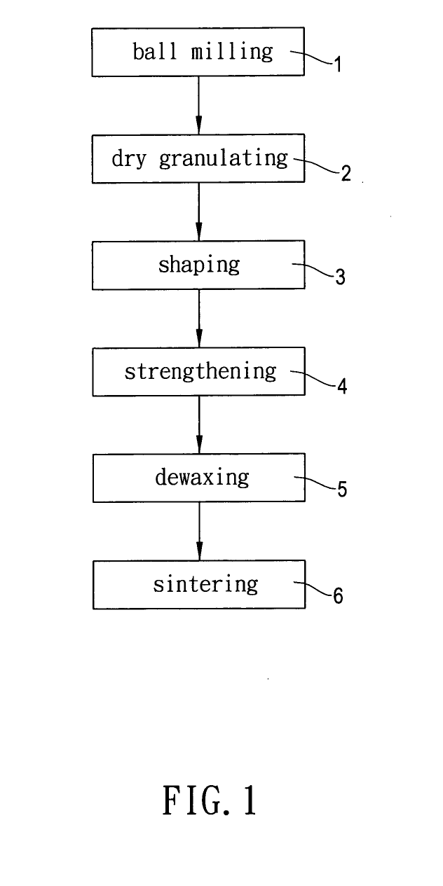

Referring to FIG. 1, the manufacturing method of the present invention comprises the following steps of:

1. wet milling: mixing and grinding indium-tin oxide (ITO) powders, a sintering aid agent, a binder agent, and additive agent by wet milling method;

2. granulation: drying the mixed and grinded mixtures to form granulated ITO powers;

3. shaping: granulated ITO powders into rough-shaped green bodies by using dry pressing;

4. Strengthening: strengthening the rough-shaped green bodies by cold isostatic pressing machine;

5. dewaxing: putting rough-shaped green bodies into a high-temperature furnace to remove the additive agent so as to obtain dewaxed green bodies; and

6. sintering: putting the dewaxed green bodies into an controlled atmosphere furnace and sintering the dewaxed green bodies at a gas pressure ranged from 1.1 atm to 1.9 atm by injecting an adoptable gas into the atmosphere furnace.

During practical manufacture process, the ITO powders are first put into wet mill or desolver. Then, water and 0.001 weight percent to 1 weight percent sintering aid agent are added into the wet mill or desolver, wherein the sintering aid agent is a mixture of K₂O, Al₂O₃, and SiO₂. Thereafter, a wet milling method is performed for mixing and grinding the mixtures until their particle dimensions are smaller than 0.2 μm. Then, a binder agent is added into the mixture and the mixing process is continued until the binder is properly dispersed. The foregoing mixture is dried to provide granulated ITO powders with a tapped density ranged from 1.2 to 1.7 g/cm². The ITO powders shaped by dry pressing at the forming pressure between 100 kg/cm² and 1000 kg/cm². The shaped ITO green bodies strengthened by cold isostatic pressing at a pressure between 200 Mpa and 300 Mpa. The strengthened ITO green bodies are put into a high-temperature furnace and the temperature is raised by 0.1 to 0.5° C. to maintain the temperature between 250° C. to 800° C. for removing the additive agent so as to obtain non-sintered dewaxed green bodies. Finally, the dewaxed green bodies are put into a controlled atmosphere furnace, which is vacuumed first and then filled with gas before use. In this preferred embodiment, the oxygen gas is adopted for exemplification. In the sintering step, the pressure of the oxygen gas is ranged from 1.1 to 1.9 atm, and the temperature is raised by 0.5 to 5° C. to maintain the temperature between 1400° C. to 1600° C. for producing sputtering targets with an ITO density over 7.08 g/cm².

In the sintering step, the pressure of the gas (oxygen gas) inside the atmosphere furnace is different from the conventional normal pressure (1 atm) so the required sintering time can be reduced effectively and the extent of decomposition can be minimized. Therefore, the weight lost of the materials can be reduced and the density of the sputtering target can be thus increased.

In summary, the present invention improves the conventional normal-pressure sintering step, which takes longer time and loses more materials, by disclosing a method of manufacturing the sputtering target so as to decrease the sintering time and the weight loss of the materials. Accordingly, the present invention satisfies patentability and is therefore submitted for a patent application.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A method of manufacturing sputtering targets comprising the steps of:
(1) wet milling: mixing and grinding indium-tin oxide (ITO) powders, a sintering aid agent, a binder agent, and an additive agent by a wet milling method;
(2) granulation: drying the mixed and grinded mixtures to form granulated ITO powers;
(3) shaping: granulated ITO powders into rough-shaped green bodies by using dry pressing;
(4) strengthening: strengthening the green bodies by using cold isostatic pressing;
(5) dewaxing: putting rough-shaped green bodies into a high-temperature furnace to remove the additive agent so as to obtain dewaxed green bodies; and
(6) sintering: putting the dewaxed non-sintered green bodies into an controlled atmosphere furnace and sintering the dewaxed green bodies at a gas pressure ranged from 1.1 atm to 1.9 atm by injecting an adoptable gas into the furnace.

2. The method of claim 1, wherein in the wet milling step, the amount of the sintering aid agent is ranged from 0.001 weight percent to 1 weight percent.

3. The method of claim 1, wherein in the wet milling step, the sintering aid agent is a mixture of K₂O, Al₂O₃, and SiO₂.

4. The method of claim 1, wherein in the granulation step, the obtained granulated ITO powders have tapped density range from 1.2 to 1.7 g/cm².

5. The method of claim 1, wherein in the shaping step, the dry pressing is at a pressure between 100 kg/cm² and 1000 kg/cm².

6. The method of claim 1, wherein in the strengthening step, cold isostatic pressing machine is at a pressure between 200 Mpa and 300 Mpa.

7. The method of claim 1, wherein in the dewaxing step, a temperature of the high-temperature furnace is raised by 0.1 to 0.5° C. to maintain the temperature between 250° C. and 800° C.

8. The method of claim 1, wherein in the sintering step, a temperature of the atmosphere furnace is raised by 0.5 to 5° C. to maintain the temperature between 1400° C. and 1600° C.

9. The method of claim 1, wherein in the sintering step, the adoptable gas is oxygen.
